(19) United States
(12) Patent Application Publication
(10) Pub. No.: US 2021/0147691 A1
(43) Pub. Date: May 20, 2021

(54) SURFACE-MODIFIED ALUMINUM OXIDE HYDROXIDE PARTICLES AS RHEOLOGY ADDITIVES IN AQUEOUS COATING AGENT COMPOSITIONS

(71) Applicant: BASF Coatings GmbH, Münster (DE)

(72) Inventors: Andreas Poppe, Münster (DE); Martina Wegener, Münster (DE); Laura Reuter, Münster (DE)

(21) Appl. No.: 17/047,286

(22) PCT Filed: Apr. 26, 2019
(86) PCT No.: PCT/EP2019/060698

§ 371 Date: Oct. 13, 2020

(30) Foreign Application Priority Data
Apr. 27, 2018 (EP) 18169868.9

(51) Int. Cl. C09D 5/00; C09D 1/00; C09D 4/00; C09D 175/04; C09D 167/00

(52) U.S. Cl. CPC C09D 5/00; C09D 1/00; C09D 167/00; C09D 175/04; C09D 4/00

(57) ABSTRACT

Described herein is an aqueous coating material composition which has a pH>7.5 and includes at least one polymer as component (A) and also aluminum oxide hydroxide particles as component (B), where component (B) is included in the composition in an amount of at least 0.1 wt %, based on the solids content of the coating material composition, and where the surface of the aluminum oxide hydroxide particles employed as component (B) is modified at least partly with at least one organic acid. Also described herein is a method for producing a multicoat paint system using the aqueous coating material composition, and a multicoat paint system thus produced.

The present invention relates to an aqueous coating material composition which has a pH≥7.5 and comprises at least one polymer as component (A) and also aluminum oxide hydroxide particles as component (B), where component (B) is included in the composition in an amount of at least 0.1 wt %, based on the solids content of the coating material composition, and where the surface of the aluminum oxide hydroxide particles employed as component (B) is modified at least partly with at least one organic acid, and also to a method for producing a multicoat paint system using the aqueous coating material composition, and to a multicoat paint system thus produced.

### PRIOR ART

Particularly in automobile finishing, but also in other sectors where there is a desire for coatings with high decorative effect and at the same time effective protection from corrosion, it is known practice to provide substrates with a plurality of coating films disposed one above another. Multicoat paint systems here are applied preferably by what is called the “basecoat/clearcoat” method, meaning that at least one “basecoat/clearcoat” method, meaning that at least one pigmented basecoat material is applied first of all and is recoated after a short flash-off time, without a baking step (wet-on-wet method), with a clearcoat material. Then basecoat and clearcoat materials together are baked. The “basecoat/clearcoat” method has acquired particular importance in the application of automotive metallic effect paints.

For environmental and economic reasons there is a demand, when applying such multicoat paint systems, more particularly when applying the basecoat film, for aqueous coating material compositions to be used, in order to minimize VOC levels.

Particularly in the sector of automotive OEM finishing it is necessary that the aforementioned “wet-on-wet” methods enable the application of film thicknesses as high as possible of aqueous paints in a time as short as possible, so that the finishing lines can be operated economically. From a technical standpoint as well it is desirable here if the aqueous paints used, especially basecoat materials, have a very high solids content and a well-pronounced structural viscosity, in other words exhibit good thixotroping behavior, in order to achieve optimum drying and outstanding orientation of any effect pigments included therein. To achieve this, suitable thixotropic agents are customarily incorporated into paints.

Moreover, coating material compositions which are used for producing basecoat films by the aforesaid “wet-on-wet” method ought to be able to be given an overlying clearcoat film after an extremely short initial drying period without a baking step, without this procedure being accompanied by defects in the visual appearance, such as, for example, what are called pinholes, pops, runs and/or (other) flow defects, so as to obtain a highly optimal visual appearance to the resultant coatings. For the purpose as well of at least minimizing such defects, suitable rheological assistants are customarily incorporated into the coating material compositions for application.

In the prior art in the sector of automotive OEM finishing it is known practice, from EP 0 281 936 A1, for example, to incorporate phyllosilicates, especially smectites such as the commercially available product Laponite® RD, as rheological assistants into aqueous coating material compositions in order to obtain such a desired profile of properties as elucidated in more detail above. These smectites used customarily have an average particle diameter in the region of 25 nm and a platelet thickness in the region of a few nanometers.

It is true that the use of such smectites often leads to pronounced structural viscosity and hence to pronounced thixotropy with comparatively short response times, something which may be an advantage particularly in terms of the orientation of effect pigments. However, in view of the comparatively small particle size of these phyllosilicates, what are customarily formed are comparatively narrow “house-of-cards structures”, something which often causes difficulties during paint application, in the coalescence phase, in allowing water or condensation products to escape from the wet films. Furthermore, owing to the comparatively small particle size of such phyllosilicates, strong stabilizing forces are often needed in order to provide adequate stabilization of the particles. These strong stabilizing forces required, however, mean that only comparatively low solids contents can be formulated and utilized—which is undesirable. Moreover, this often results in restrictions on the electrolyte content of the aqueous paints and hence on the stability of the aqueous paints. Given that no alternative synthetic phyllosilicate products and more particularly smectite products with significantly larger particle sizes are available on the market, the formulation options using the known Laponite® RD systems are limited, particularly if aqueous paints with a high solids content are to be used.

There is therefore a need for aqueous coating material compositions which do not exhibit the disadvantages identified above.

### Problem

A problem addressed by the present invention is therefore that of providing an aqueous coating material composition such as an aqueous basecoat composition which can be formulated with comparatively high solids content, and more particularly with higher solids content than coating material compositions known from the prior art, but which at the same time is distinguished by application properties which are at least a match for and are preferably even better than those of coating material compositions known from the prior art, particularly with regard to the visual appearance of the resultant coatings, more particularly in respect of the incidence of pinholes, pops, and runs, and which likewise exhibits no disadvantages, instead, on the contrary, preferably displaying advantages in terms of its structural viscosity and its thixotroping behavior.

### Solution

This problem is solved by the subject matter claimed in the claims and also by the preferred embodiments of that subject matter that are described in the description hereinafter.

A first subject of the present invention is therefore an aqueous coating material composition comprising at least
(A) at least one polymer employable as binder, as component (A), and
(B) aluminum oxide hydroxide particles, as component (B),
   where the aqueous coating material composition has a pH≥7.5,
   wherein the coating material composition comprises component (B) in an amount of at least 0.1 wt %, based on the solids content of the coating material composition, and the surface of the aluminum oxide hydroxide particles employed as component (B) is at least partly modified with at least one organic acid.

This aqueous coating material composition is also referred to hereinafter as “coating material composition of the invention”. The solids content of this coating material composition of the invention is preferably >25 wt %, based on the total weight of the coating material composition. With preference, the coating material composition of the invention is a basecoat material.

A further subject of the present invention is a method for producing a multicoat paint system, in which
(1a) an aqueous basecoat material is applied to an optionally coated substrate,
(2a) a polymer film is formed from the coating material applied in stage (1a),
(1b) optionally a further aqueous basecoat material is applied to the polymer film thus formed,
(2b) optionally a polymer film is formed from the coating material applied in stage (1b),
(3) a clearcoat material is applied to the resulting basecoat film or films, and subsequently
(4) the basecoat film or films is or are jointly cured together with the clearcoat film,
   wherein the aqueous coating material composition of the invention is used as basecoat material in stage (1a) or—where the method further comprises stages (1b) and (2b)—as basecoat material in stage (1a) and/or (1b).

This method is also referred to hereinafter as “method of the invention”.

It has surprisingly been found that the aqueous coating material composition of the invention, as a result of the incorporation of the specific aluminum oxide hydroxide particles as component (B), can be formulated with a comparatively high solids content, more particularly with a solids content of >25 wt %. In this way it is possible in particular to achieve a higher solids content than with coating material compositions known from the prior art, and more particularly than with those which contain a phyllosilicate such as Laponite® RD as rheological assistant. It has surprisingly been found, moreover, that at the same time—in spite of the comparatively high solids content—the application properties of the aqueous coating material composition of the invention are at least as good as and in some cases even better than those of coating material compositions known from the prior art, such as, in particular, coating material compositions which include a phyllosilicate such as Laponite® RD as rheological assistant. This is the case, in particular, even in relation to a comparison with the visual appearance of the respective resultant coatings, particularly on application in accordance with the method of the invention, and especially in relation to the incidence of pinholes, pops, and runs. Furthermore, this is also valid with regard to the structural viscosity and the thixotroping behavior of the respective coating material compositions.

It has surprisingly been found that on incorporation of the specific aluminum oxide hydroxide particles as component (B), advantageously, strong stabilizing forces are not necessary in order to provide the particles with sufficient stabilization in the production of the aqueous coating material composition of the invention, meaning that comparatively high solids contents can be formulated. Surprisingly, indeed, the average particle size of the specific aluminum oxide hydroxide particles employed is significantly increased when they are used for producing the aqueous coating material composition of the invention, and so the aluminum oxide hydroxide particles employed as component (B) have a significantly higher average particle size than, for example, phyllosilicates known from the prior art, such as Laponite® RD when they are incorporated into aqueous coating material compositions.

### DETAILED DESCRIPTION

In the sense of the present invention, in connection with the coating material composition of the invention, the term “comprising” preferably has the meaning of “consisting of”. With regard to the coating material composition of the invention, as well as the components (A), (B), and water, there may be one or more of the further components, identified below as present optionally in the coating material composition of the invention, actually included therein. All components here may each be present in their preferred embodiments as specified hereinafter.

The proportions in wt % of all components (A), (B), and water present in the coating material composition of the invention, and also of further components optionally present additionally, add up to 100 wt %, based on the total weight of the coating material composition.

The terms “pops”, “runs”, “pinholes”, “bits”, “rheological assistants” (“rheological additive”) and also “flow defects” and “flow”, respectively, are known to the skilled person and are defined for example in Römpp Lexikon, Lacke and Druckfarben, Georg Thieme Verlag 1998.

### Coating Material Composition

The aqueous coating material composition of the invention has a pH≥7.5, preferably a pH in a range from ≥7.5 to 13.0. More preferably the pH is in a range from ≥7.5 to 12.5, very preferably in a range from 7.6 to 12.0, more preferably still in a range from 7.7 to 11.5 or to 11.0. Most preferred is a pH in a range from 7.8 to 10.5 or to 10.0, more particularly from 8.0 to 9.5.

The aqueous coating material composition of the invention is suitable preferably for producing a basecoat film. With particular preference, therefore, the coating material of the invention is an aqueous basecoat material. The concept of the basecoat material is known to the skilled person and defined for example in Römpp Lexikon, Lacke and Druckfarben, Georg Thieme Verlag, 1998, 10^{th} edition, page 57. A basecoat material, accordingly, is more particularly an intermediate coating material which is employed in automobile finishing and general industrial coating and which imparts color and/or imparts color and an optical effect. It is generally applied to a metallic or plastics substrate which has been pretreated with surfacer or primer-surfacer, sometimes also directly to the plastics substrate in the case of plastics substrates and, in the case of metal substrates, to an electrocoat film with which the metal substrate has been coated. Existing paint finishes as well, which optionally require pretreatment additionally (by being sanded, for example), may serve as substrates. Now, moreover, it is entirely customary for more than one basecoat film to be applied. In such a case, accordingly, a first basecoat film constitutes the substrate for a second film. In order to protect a basecoat film from environmental influences in particular, at least one additional clearcoat film is applied over it.

The coating material composition of the invention is aqueous. It is preferably a system which comprises primarily water as solvent, preferably in an amount of at least 20 wt %, and organic solvents in smaller proportions, preferably in an amount of <20 wt %, based in each case on the total weight of the coating material composition of the invention.

The coating material composition of the invention preferably includes a water fraction of at least 20 wt %, more preferably of at least 25 wt %, very preferably of at least 30 wt %, more particularly of at least 35 wt %, based in each case on the total weight of the coating material composition of the invention.

The coating material composition of the invention preferably includes a water fraction which is in a range from 20 to 65 wt %, more preferably in a range from 25 to 60 wt %, very preferably in a range from 30 to 55 wt %, based in each case on the total weight of the coating material composition of the invention.

The coating material composition of the invention preferably includes an organic solvent fraction which is in a range of <20 wt %, more preferably in a range from 0 to <20 wt %, very preferably in a range of 0.5 to <20 wt % or to 15 wt %, based in each case on the total weight of the coating material composition of the invention.

All customary organic solvents known to the skilled person may be employed as organic solvent for producing the coating material composition of the invention. The term “organic solvent” is known to the skilled person, in particular from Council Directive 1999/13/EC of Mar. 11, 1999 (identified therein as solvent). The organic solvent or solvents are preferably selected from the group consisting of mono- or polyhydric alcohols, examples being methanol, ethanol, 1-propanol, 2-propanol, 1-butanol, ethylene glycol, ethyl glycol, propyl glycol, butyl glycol, butyl diglycol, 1,2-propanediol and/or 1,3-propanediol, ethers, examples being diethylene glycol dimethyl ethers, aliphatic hydrocarbons, aromatic hydrocarbons, examples being toluene and/or xylenes, ketones, examples being acetone, N-methylpyrrolidone, N-ethylpyrrolidone, methyl isobutyl ketone, isophorone, cyclohexanone, and methyl ethyl ketone, esters, examples being methoxypropyl acetate, ethyl acetate and/or butyl acetate, amides, an example being dimethylformamide, and mixtures thereof.

The solids content of the coating material composition of the invention is preferably >25 wt %, based in each case on the total weight of the coating material composition. The solids content, in other words the nonvolatile fraction, is determined in accordance with the method described below. The solids content of the coating material composition of the invention is preferably in a range from >25 to 50 wt %, more preferably from >25 to 45 wt %, very preferably from >25 to 40 wt %, more particularly from >25 to 37.5 wt %, most preferably from >25 to 35 wt %, based in each case on the total weight of the coating material composition of the invention. The expression “>25 wt %” here encompasses in each case, in particular, the numerical point values of 26, 27, 28, 29, 30, 31, 32, 33 and 34 wt % as the lower limit.

The percentage sum of the solids content of the coating material composition of the invention and the water fraction in the coating material composition of the invention is preferably at least 40 wt %, more preferably at least 50 wt %. Preferred therein are ranges from 40 to 95 wt %, more particularly 45 or 50 to 90 wt %. If, therefore, a coating material composition of the invention has, for example, a solids content of 30 wt % and a water content of 25 wt %, then the above-defined percentage sum of the solids content and the water fraction is 55 wt %.

The coating material composition of the invention preferably comprises a fraction of the at least one polymer (A) employed as binder in a range from 1.0 to 25 wt %, more preferably from 1.5 to 20 wt %, very preferably from 2.0 to 18.0 wt %, more particularly from 2.5 to 17.5 wt %, most preferably from 3.0 to 15.0 wt %, based in each case on the total weight of the coating material composition of the invention. The determination or specification of the fraction of the polymer (A) in the coating material composition of the invention may be done by way of the determination of the solids content (also called nonvolatile fraction, solids or solids fraction) of an aqueous dispersion comprising the polymer (A) that is then used for producing the coating material composition.

The aqueous coating material composition of the invention comprises the aluminum oxide hydroxide particles employed as component (B) in an amount of at least 0.1 wt %, preferably of at least 0.5 wt %, more preferably of at least 0.75 wt %, very preferably of at least 1.0 or of at least 1.5 wt %, based in each case on the solids content of the coating material composition. The aluminum oxide hydroxide particles employed as component (B) are present in the coating material composition preferably in an amount in a range from 0.1 wt % to 20 wt %, more preferably from 0.5 wt % to 15 wt %, very preferably from 1.0 to 12.5 wt %, more particularly from 1.5 wt % to 10 wt %, based in each case on the solids content of the coating material composition.

The aqueous coating material composition of the invention preferably comprises the aluminum oxide hydroxide particles employed as component (B) in an amount of at least 0.05 wt %, more preferably of at least 0.25 wt %, very preferably of at least 0.50 wt % or of at least 0.75 wt %, more preferably still of at least 1.0 wt %, more particularly of at least 1.5 wt %, based in each case on the total weight of the coating material composition.

The fraction in wt %, based on the total weight of the coating material composition, of component (A) in the coating material composition of the invention is preferably higher than the fraction of component (B).

The relative weight ratio of component (B) to component (A) in the coating material composition of the invention is preferably in a range from 1:1 to 1:20 or from 1:1 to 1:15 or from 1:1.1 to 1:20 or from 1:1.1 to 1:15 or from 1:1.1 to 1:10, more preferably in a range from 1:1.2 to 1:8, very preferably in a range from 1:1.3 to 1:7.5, more preferably still in a range from 1:1.4 to 1:7, more particularly in a range from 1:1.5 to 1:6.5, more preferably still in a range from 1:1.6 to 1:6, most preferably in a range from 1:2 to 1:5.

The coating material composition of the invention preferably contains no melamine resin in an amount >5 wt %, based on the solids content of the coating material composition. With particular preference the coating material composition of the invention contains no melamine resin at all.

The coating material composition of the invention preferably contains no polyester having an acid number <5 mg KOH/g polyester in an amount >5 wt %, based on the solids content of the coating material composition. With particular preference the coating material composition of the invention contains no polyester at all with an acid number <5 mg KOH/g polyester.

### Component (A)

The aqueous coating material composition of the invention comprises at least one polymer, as component (A). This polymer is employed as binder. The term “binder” in the sense of the present invention, in agreement with DIN EN ISO 4618 (German version, date: March 2007), refers to those nonvolatile fractions of a coating material composition that are responsible for film formation. Pigments and/or fillers in the composition are therefore not subsumed by the term “binder”. Preferably the at least one polymer (A) is the principal binder of the coating material composition. A binder constituent is termed principal binder for the purposes of the present invention preferably when there is no other binder constituent in the coating material composition such as a basecoat material that is present in a higher fraction, based on the total weight of the respective coating material composition.

The term “polymer” is known to the skilled person and in the sense of the present invention encompasses not only polyadducts but also chain-growth addition polymers and polycondensates. Both homopolymers and copolymers are subsumed by the term “polymer”.

The at least one polymer employed as component (A) may be self-crosslinking or nonself-crosslinking. Suitable polymers employable as component (A) are known for example from EP 0 228 003 A1, DE 44 38 504 A1, EP 0 593 454 B1, DE 199 48 004 A1, EP 0 787 159 B1, DE 40 09 858 A1, DE 44 37 535 A1, WO 92/15405 A1 and WO 2005/021168 A1.

The at least one polymer employed as component (A) is preferably selected from the group consisting of polyurethanes, polyureas, polyesters, polyamides, polyethers, poly(meth)acrylates and/or copolymers of the stated polymers, more particularly polyurethane-poly(meth)acrylates and/or polyurethane-polyureas. With particular preference the at least one polymer employed as component (A) is selected from the group consisting of polyurethanes, polyesters, poly(meth)acrylates and/or copolymers of the stated polymers. The expression “(meth)acrylic” or “(meth)acrylate” in the sense of the present invention encompasses in each case the definitions “methacrylic” and/or “acrylic” and, respectively, “methacrylate” and/or “acrylate”.

Preferred polyurethanes are described for example in German patent application DE 199 48 004 A1, page 4, line 19 to page 11, line 29 (polyurethane prepolymer B1); in European patent application EP 0 228 003 A1, page 3, line 24 to page 5, line 40; in European patent application EP 0 634 431 A1, page 3, line 38 to page 8, line 9; and in international patent application WO 92/15405, page 2, line 35 to page 10, line 32.

Preferred polyesters are described for example in DE 4009858 A1 in column 6, line 53 to column 7, line 61 and column 10, line 24 to column 13, line 3, or in WO 2014/033135 A2, page 2, line 24 to page 7, line 10 and also page 28, line 13 to page 29, line 13. Likewise preferred polyesters are polyesters with dendritic structure of the kind described for example in WO 2008/148555 A1. They can be used not only in clearcoat materials but also in basecoat materials, especially aqueous basecoat materials.

Preferred polyurethane-poly(meth)acrylate copolymers ((meth)acrylated polyurethanes) and their preparation are described for example in WO 91/15528 A1, page 3, line 21 to page 20, line 33, and in DE 4437535 A1, page 2, line 27 to page 6, line 22.

Preferred poly(meth)acrylates are those preparable by multistage radical emulsion polymerization of olefinically unsaturated monomers in water and/or organic solvents. Particularly preferred are seed-core-shell polymers (SCS polymers), for example. Such polymers, and aqueous dispersions containing such polymers, are known from WO 2016/116299 A1, for example. Particularly preferred seed-core-shell polymers are polymers—preferably those having an average particle size of 100 to 500 nm—which are preparable by successive radical emulsion polymerization of three monomer mixtures (A), (B), and (C)—preferably different from one another of olefinically unsaturated monomers in water, with mixture (A) containing at least 50 wt % of monomers having a solubility in water of less than 0.5 g/l at 25° C., and with a polymer prepared from the mixture (A) possessing a glass transition temperature of 10 to 65° C.; mixture (B) contains at least one polyunsaturated monomer, and a polymer prepared from the mixture (B) possesses a glass transition temperature of −35 to 15° C.; and a polymer prepared from the mixture (C) possesses a glass transition temperature of −50 to 15° C.; and where i. first the mixture (A) is polymerized, ii. then the mixture (B) is polymerized in the presence of the polymer prepared in i. and iii. thereafter the mixture (C) is polymerized in the presence of the polymer prepared in ii.

Preferred polyurethane-polyurea copolymers are polyurethane-polyurea particles, preferably those having an average particle size of 40 to 2000 nm, where the polyurethane-polyurea particles, in each case in reacted form, comprise at least one polyurethane prepolymer containing isocyanate groups and comprising anionic groups and/or groups which can be converted into anionic groups, and also at least one polyamine containing two primary amino groups and one or two secondary amino groups. Copolymers of this kind are used preferably in the form of an aqueous dispersion. Such polymers are preparable in principle by conventional polyaddition of, for example, polyisocyanates with polyols and also polyamines.

The polymer employed as component (A) preferably has reactive functional groups which enable a crosslinking reaction. Any customary crosslinkable reactive functional group known to the skilled person is suitable here. The polymer employed as component (A) preferably has at least one kind of functional reactive groups selected from the group consisting of primary amino groups, secondary amino groups, hydroxyl groups, thiol groups, carboxyl groups, and carbamate groups. The polymer employed as component (A) preferably has functional hydroxyl groups.

The polymer employed as component (A) is preferably hydroxy-functional and with more particular preference possesses an OH number in the range from 15 to 200 mg KOH/g, more preferably from 20 to 150 mg KOH/g.

With particular preference the polymer used as component (A) is a hydroxy-functional polyurethane-poly(meth)acrylate copolymer, a hydroxy-functional polyester and/or a hydroxy-functional polyurethane-polyurea copolymer.

Moreover, the aqueous coating material composition of the invention may comprise at least one typical crosslinking agent known per se. Crosslinking agents are subsumed under those nonvolatile fractions of a coating material composition that are responsible for film formation, and therefore fall within the general definition of the binder. Crosslinking agents are therefore subsumed under component (A).

If a crosslinking agent is present, it is preferably at least one amino resin and/or at least one blocked or free polyisocyanate, preferably an amino resin. Preferred among the amino resins in particular are melamine resins such as melamine-formaldehyde resins.

### Component (B)

The aqueous coating material composition of the invention comprises aluminum oxide hydroxide particles as component (B), the surface thereof being at least partly modified with at least one organic acid.

The term “aluminum oxide hydroxide” is known to the skilled person. It subsumes compounds having the chemical formula AlO(OH) or γ-AlO(OH). Particular examples of aluminum oxide hydroxides are boehmite and pseudoboehmite. Boehmite particles are used with preference as component (B).

The surface of the aluminum oxide hydroxide particles used as component (B) is modified at least partly with at least one organic acid. In the sense of the present invention, the term “modification” is understood preferably as a treatment of component (B) such as of the boehmite particles with at least one organic acid.

Accordingly, the at least partial modification is accomplished preferably by treatment of the aluminum oxide hydroxide particles with at least one organic acid, preferably with formation of ionic and/or covalent groups. If this component (B) thus modified, such as boehmite particles, is incorporated into an aqueous application medium, such as into the aqueous coating material composition of the invention that has a pH≥7.5, then the surface treatment that has taken place with at least one organic acid means that a “charge reversal” in this pH range can take place, and the modified boehmite particles have an at least partly anionically charged surface and can therefore be incorporated into the aqueous medium and are compatible therewith.

Aluminum oxide hydroxide particles whose surface is at least partly modified with at least one organic acid are known in the prior art: for instance, U.S. Pat. No. 6,224,846 B1 describes boehmite particles modified by means of organic sulfonic acids in order to allow such boehmite particles to be dispersed in water and in polar organic solvents. U.S. Pat. No. 7,244,498 B2 discloses nanoparticles such as boehmite nanoparticles which are subjected using organic acids to a surface modification to generate a negative surface charge. Lastly, corresponding boehmite products modified at least partly with at least one organic acid are available commercially and are sold for example under the designations “Disperal® HP 14/7”, “Disperal® HP 10/7”, and “Disperal® HP 18/7” by Sasol.

For the sake of completeness it may be noted that further modifications of the surface of boehmite particles are likewise known in the prior art. For instance, M. L. Nobel et al., in Progress in Organic Coatings 2007, 58, pages 96-104, describe acrylic polymer nanocomposite materials which contain boehmite, where the surface of the boehmite particles may be modified using titanium alkoxides. Surface modification of this kind, however, does not result in anionic stabilization of the Al surface of the boehmite.

Corresponding unmodified boehmite particles, in contrast, have a cationic surface in an aqueous medium with a pH≥7.5, and under these conditions are not employable. Such unmodified boehmite particles are therefore customarily employed exclusively in an acidic application medium. Such a use of such unmodified boehmite particles is disclosed for example in WO 2004/031090 A2 and in WO 2006/060510 A1 and also in US 2008/0090012 A1. Unmodified boehmite particles and the use thereof as fillers in polymer composite materials are known, moreover, from WO 03/089508 A1. Unmodified boehmite particles therefore cannot be used at a pH≥7.5.

As mentioned above, the surface of the aluminum oxide hydroxide particles used as component (B) is at least partially modified with at least one preferably aliphatic organic acid. The organic acid preferably has at least two, more preferably at least three acid groups. Acid groups contemplated are, in particular, carboxylic acid groups and/or acid groups which contain at least one S or at least one P atom. Examples of S-atom-containing acid groups are sulfonic acid groups and sulfinic acid groups. Examples of P-atom-containing acid groups are phosphoric acid and phosphonic acid groups and also their partial or full esters such as monoesters and diesters. However, carboxylic acid groups (carboxyl groups) are preferred. Preferably, therefore, the organic acid has at least two, more preferably at least three, carboxyl groups. The at least one organic acid employed is therefore preferably a carboxylic acid, more preferably a carboxylic acid having at least two or at least three carboxyl groups. Examples of organic acids which can be used are citric acid, lactic acid, oxalic acid, malonic acid, succinic acid, glutaric acid, adipic acid, pimelic acid, suberic acid, azelaic acid, sebacic acid, tartaric acid, malic acid, aspartic acid, oxalosuccinic acid, trimellitic acid, isocitric acid and aconitic acid, and also mixtures thereof. Analogously, the corresponding anhydrides can also be employed.

The surface of the aluminum oxide hydroxide particles used as component (B) is preferably modified at least partially with citric acid as at least one organic acid.

The aluminum oxide hydroxide particles used as component (B) are present preferably, in the aqueous coating material composition, in the form of particles having an average particle size (d₅₀) of 750 nm, where the average particle size refers to the arithmetic number average of the average particle diameter, and the average particle size is determined by means of photon correlation spectroscopy (PCS). With particular preference the aluminum oxide hydroxide particles used as component (B) are present in the aqueous coating material composition in the form of particles having an average particle size in a range of 75 nm to 750 nm. The average particle size is determined preferably using the “Zetasizer Nano S-173” instrument from Malvern Instruments in accordance with DIN ISO 13321 (date: October 2004) in an aqueous dispersion containing 0.01 to 0.1 wt % of the particles (B), more preferably at a pH in the range of >7.5 to 11.

The aluminum oxide hydroxide particles used as component (B) are present preferably, in the aqueous coating material composition, in the form of particles having an average particle size in a range of ≥75 nm to ≤300 nm, where the average particle size refers to the arithmetic number average of the average particle diameter, and the average particle size is determined by means of photon correlation spectroscopy (PCS) using the “Zetasizer Nano S-173” instrument from Malvern Instruments in accordance with DIN ISO 13321 (date: October 2004) in an aqueous dispersion containing 0.1 wt % of the particles (B) at a pH of 9.3. With particular preference the aluminum oxide hydroxide particles take the form here of particles having an average particle size in a range from 100 nm to 250 nm, very preferably 100 nm to 200 nm.

The aluminum oxide hydroxide particles used as component (B) are present preferably, in the aqueous coating material composition, in the form of particles having an average particle size in a range of ≥50 nm to ≤600 nm, where the average particle size refers to the arithmetic number average of the average particle diameter, and the average particle size is determined by means of photon correlation spectroscopy (PCS) using the “Zetasizer Nano S-173” instrument from Malvern Instruments in accordance with DIN ISO 13321 (date: October 2004) in an aqueous dispersion of the particles (B). With particular preference the aluminum oxide hydroxide particles take the form here of particles having an average particle size in a range from ≥100 nm to ≤550 nm, very preferably ≥120 nm to ≤500 nm.

Before being incorporated into the composition, in other words when present in the form of a solid powder, the particles (B) used in producing the aqueous coating material composition of the invention preferably have an average particle size in a range from 5 to 50 μm, more preferably in a range from 15 to 45 μm, very preferably in a range from 20 to 40 μm. The average particle size is determined here using the “Mastersizer 3000” instrument from Malvern Instruments at 25±1° C. in its Aero unit. The average particle size in this connection refers to the volume average of the mean particle diameter measured (V-average mean).

Before being incorporated into the composition, in other words when present in the form of a solid powder, the particles (B) used in producing the aqueous coating material composition of the invention preferably have a crystallite particle size in a range from 5 to 80 nm, more preferably in a range from 7.5 to 50 nm. The crystallite particle size is determined here by means of X-ray diffractometry using conventional X-ray diffractometers from Siemens or Philips.

The aluminum oxide hydroxide particles used as component (B) preferably have an electrical conductivity of >750 μS/cm, more preferably an electrical conductivity in a range from >750 μS/cm to 2500 μS/cm, especially when these particles (B) are incorporated into an aqueous dispersion containing these particles in an amount of 15 to 25 wt %, most preferably on incorporation of these particles (B) into an aqueous dispersion containing these particles in an amount of 20 wt %, based in each case on the total weight of such a dispersion. Very preferably the aluminum oxide hydroxide particles used as component (B) here have an electrical conductivity in a range from 800 μS/cm to 2000 μS/cm. This is advantageous in view of the desire for as low as possible an electrical conductivity on the part of the coating material composition of the invention, such as a basecoat material of the invention, since it entails a greater stability.

The aluminum oxide hydroxide particles used as component (B) preferably have an isoelectric point of <pH 10, more preferably of <pH 9, in each case preferably of ≥7.5.

### Further, Optional Components

The aqueous coating material composition of the invention may comprise at least one further, optional component, different from the components (A), (B), and water.

### Pigments & Fillers as Further, Optional Component(s)

The aqueous coating material composition of the invention may comprise at least one pigment and/or at least one filler. The term “pigment” here encompasses color pigments and effect pigments.

A skilled person is familiar with the concept of effect pigments. A corresponding definition is found for example in Römpp Lexikon, Lacke and Druckfarben, Georg Thieme Verlag, 1998, 10th edition, pages 176 and 471. A definition of pigments in general, and further specifications thereof, are dealt with in DIN 55943 (date: October 2001). The effect pigments are preferably pigments which impart optical effect or impart color and optical effect, more particularly optical effect. With preference, therefore, the terms “optical effect and color pigment”, “optical effect pigment”, and “effect pigment” are interchangeable.

Preferred effect pigments are, for example, lamellar metallic effect pigments such as leaflet-like aluminum pigments, gold bronzes, oxidized bronzes and/or iron oxide-aluminum pigments, pearlescent pigments such as pearl essence, basic lead carbonate, bismuth oxychloride and/or metal oxide-mica pigments, and/or other effect pigments such as leaflet-like graphite, leaflet-like iron oxide, multilayer effect pigments comprising PVD films, and/or liquid crystal polymer pigments. Particularly preferred are leaflet-like effect pigments, more particularly leaflet-like aluminum pigments and metal oxide-mica pigments. As at least one effect pigment for producing the coating material composition of the invention therefore, use is made as at least one effect pigment of at least one metallic effect pigment such as at least one preferably leaflet-like aluminum effect pigment and/or at least one metal oxide-mica pigment.

The fraction of the effect pigments in the coating material composition is preferably in the range from 1.0 to 25.0 wt %, more preferably 1.5 to 20.0 wt %, very preferably 2.0 to 15.0 wt %, based in each case on the total weight of the aqueous coating material composition.

A skilled person is familiar with the concept of color pigments. The terms “coloring pigment” and “color pigment” are interchangeable. As color pigment it is possible to use organic and/or inorganic pigments. The color pigment is preferably an inorganic color pigment. Particularly preferred color pigments used are white pigments, chromatic pigments and/or black pigments. Examples of white pigments are titanium dioxide, zinc white, zinc sulfide, and lithopone. Examples of black pigments are carbon black, iron manganese black, and spinel black. Examples of chromatic pigments are chromium oxide, chromium oxide hydrate green, cobalt green, ultramarine green, cobalt blue, ultramarine blue, manganese blue, ultramarine violet, cobalt and manganese violet, red iron oxide, cadmium sulfoselenide, molybdate red, and ultramarine red, brown iron oxide, mixed brown, spinel phases and corundum phases, and chromium orange, yellow iron oxide, nickel titanium yellow, chromium titanium yellow, cadmium sulfide, cadmium zinc sulfide, chromium yellow, and bismuth vanadate.

The fraction of the color pigments in the coating material composition is preferably in the range from 1.0 to 40.0 wt %, more preferably 2.0 to 35.0 wt %, very preferably 5.0 to 30.0 wt %, based in each case on the total weight of the aqueous coating material composition.

As pigment or pigments, the aqueous coating material composition of the invention preferably comprises exclusively one or more color pigments. In other words, the aqueous coating material composition of the invention contains preferably no effect pigment(s).

The term “filler” is known to the skilled person, from DIN 55943 (date: October 2001), for example. A “filler” in the sense of the present invention is a substance which is substantially insoluble in the application medium, such as in the coating material composition of the invention, for example, and which is used in particular for increasing the volume. In the sense of the present invention, “fillers” are preferably different from “pigments” by virtue of their refractive index, which for fillers is <1.7, while for pigments it is ≥1.7. Examples of suitable fillers are kaolin, dolomite, calcite, chalk, calcium sulfate, barium sulfate, talc, silicas, especially fumed silicas, hydroxides such as aluminum hydroxide or magnesium hydroxide or organic fillers such as textile fibers, cellulose fibers and/or polyethylene fibers; for further details, refer to Römpp Lexikon, Lacke and Druckfarben, Georg Thieme Verlag, 1998, pages 250 ff., “Fillers”.

The fraction of the fillers in the coating material composition is preferably in the range from 1.0 to 40.0 wt %, more preferably 2.0 to 35.0 wt %, very preferably 5.0 to 30.0 wt %, based in each case on the total weight of the aqueous coating material composition.

### Thickeners as Further Optional Component

The aqueous coating material composition of the invention may optionally further comprise at least one thickener (also known as thickening agent). As already mentioned above, this thickener is then different from components (A) and (B).

Examples of such thickeners are inorganic thickeners, examples being metal silicates such as phyllosilicates, and organic thickeners, examples being poly(meth)acrylic acid thickeners and/or (meth)acrylic acid-(meth)acrylate copolymer thickeners, polyurethane thickeners, and also polymeric waxes. The metal silicate is selected preferably from the group of smectites. Particularly preferred for selection are the smectites from the group of the montmorillonites and hectorites. Selected more particularly are the montmorillonites and hectorites from the group consisting of aluminum magnesium silicates and also sodium magnesium phyllosilicates and sodium magnesium fluorine lithium phyllosilicates. These inorganic phyllosilicates are sold under the brand name Laponite®, for example. Preferably, however, the coating material composition of the invention contains no such inorganic phyllosilicate and more particularly no aluminum magnesium silicate, sodium magnesium phyllosilicate and/or sodium magnesium fluorine lithium phyllosilicate. Thickeners based on poly(meth)acrylic acid and (meth)acrylic acid-(meth)acrylate copolymer thickeners are optionally crosslinked and/or neutralized with a suitable base. Examples of such thickeners are “Alkali Swellable Emulsions” (ASE), and hydrophobically modified variants thereof, the “Hydrophobically modified Alkali Swellable Emulsions” (HASE). These thickeners are preferably anionic. Corresponding products such as Rheovis® AS 1130 are available commercially. Thickeners based on polyurethanes (e.g., associative polyurethane thickeners) are optionally crosslinked and/or neutralized with a suitable base. Corresponding products such as Rheovis® PU 1250 are available commercially. Examples of suitable polymeric waxes include optionally modified polymeric waxes based on ethylene-vinyl acetate copolymers. A corresponding product is available commercially under the Aquatix® 8421 designation, for example.

In the coating material composition of the invention, the at least one thickener is present preferably in an amount of at most 10 wt %, more preferably at most 7.5 wt %, very preferably at most 5 wt %, more particularly at most 3 wt %, most preferably at most 2 wt %, based in each case on the total weight of the coating material composition. The minimum amount of thickener here is preferably in each case 0.1 wt %, based on the total weight of the coating material composition.

### Conventional Additives as Further Optional Component(s)

Depending on desired application, the coating material composition of the invention may comprise one or more typically employed additives as further optional component(s). For example, as already observed above, the coating material composition may include a defined fraction of at least one organic solvent. Further, the coating material composition may comprise at least one additive selected from the group consisting of reactive diluents, light stabilizers, antioxidants, deaerating agents, emulsifiers, slip additives, polymerization inhibitors, radical polymerization initiators, adhesion promoters, flow control agents, film-forming assistants, sag control agents (SCAs), flame retardants, corrosion inhibitors, siccatives, biocides, and flatting agents. They may be used in the known and customary proportions. The amount thereof, based on the total weight of the coating material composition of the invention, is preferably 0.01 to 20.0 wt %, more preferably 0.05 to 15.0 wt %, very preferably 0.1 to 10.0 wt %, especially preferably 0.1 to 7.5 wt %, more particularly 0.1 to 5.0 wt %, and most preferably 0.1 to 2.5 wt %.

### Production Methods

The coating material composition may be produced using the mixing methods and mixing assemblies customary and known for the production of coating material compositions, and/or using customary dissolvers and/or stirrers.

Method for Producing a Multicoat Paint System & Multicoat Paint System

A further subject of the present invention is a method for producing a multicoat paint system, in which
(1a) an aqueous basecoat material is applied to an optionally coated substrate,
(2a) a polymer film is formed from the coating material applied in stage (1a),
(1b) optionally a further aqueous basecoat material is applied to the polymer film thus formed,
(2b) optionally a polymer film is formed from the coating material applied in stage (1b),
(3) a clearcoat material is applied to the resulting basecoat film or films, and subsequently
(4) the basecoat film or films is or are jointly cured together with the clearcoat film,
   wherein the coating material composition of the invention is used as basecoat material in stage (1a) or—where the method further comprises stages (1b) and (2b)—as basecoat material in stage (1a) and/or (1b), preferably only in stage (1b) as basecoat material.

The method of the invention preferably comprises stages (1b) and (2b) and the substrate used in stage (1a) is a metallic substrate whose surface for coating in stage (1a) has been provided at least with a preferably cured electrocoat film.

All of the above-stated (preferred) observations relating to the coating material composition of the invention are also valid for the method of the invention. The method is employed preferably for producing effect or color, or color and effect, multicoat paint systems.

Application of the basecoat material in stage (1a) may take place to metal or plastics substrates pretreated at least with surfacer or primer-surfacer. In that case the method of the invention preferably does not include stages (1b) and (2b).

Alternatively, the basecoat material in stage (1a) may be applied to the substrate without the use of a surfacer or a primer-surfacer, in which case, in particular, the metal substrate then used preferably has an electrocoat film.

If a metal substrate is to be coated, it is preferably further coated with an electrocoat system before the application of the surfacer or primer-surfacer or of the basecoat material in accordance with stage (1a). Where a plastics substrate is coated, it is preferably further pretreated before the application of the surfacer or primer-surfacer or of the basecoat material in accordance with stage (1a). The methods most commonly employed for such pretreatment are flaming, plasma treatment, and corona discharge. Flaming is employed with preference.

The substrate used in stage (1a) preferably has an electrocoat (EC) film as (preliminary) coating, more preferably an electrocoat film applied by cathodic deposition of an electrocoat material, and the basecoat material employed in stage (1a) is applied directly to the EC-coated, preferably metallic substrate, with the electrocoat (EC) film applied to the substrate having preferably already been cured when stage (1a) is carried out. In stage (4), preferably, the basecoat film applied to the preferably metallic substrate coated with a preferably cathodic cured electrocoat film, in accordance with stages (1a) and (2a), the further basecoat film applied optionally thereto in accordance with stages (1b) and (2b), and the clearcoat film applied thereto in turn in accordance with stage (3), are jointly cured. In this case, in particular, the method of the invention preferably comprises stages (1b) and (2b)—that is, at least two basecoat films are applied, with the coating material composition of the invention being used as basecoat material within stages (1a) and/or (1b), more preferably only within stage (1b).

Application of the aqueous coating material composition(s) of the invention as basecoat material(s) may take place in the film thicknesses customary in the context of the automobile industry, in the range from, for example, 5 to 100 micrometers, preferably 5 to 60 micrometers, especially preferably 5 to 30 micrometers. This is done using spray application techniques, such as compressed air spraying, airless spraying, high-speed rotation, electrostatic spray application (ESTA), optionally in conjunction with hot spray application such as hot air spraying, for example.

Following the application of the aqueous coating material composition(s) of the invention as basecoat material(s), it or they can be dried by known techniques. For example (1-component) basecoat materials, which are preferred, can be flashed off at room temperature (20-23° C.) for 1 to 60 minutes and subsequently dried preferably at possibly slightly elevated temperatures of 25 or 30 to 90° C. Flashing off and drying in the context of the present invention refers to evaporation of organic solvents and/or water, the paint becoming drier as a result but not yet being cured—or as yet no fully crosslinked coating film is formed.

Where the method of the invention comprises stages (1b) and (2b), flashing off and/or drying at room temperature (20-23° C.) or at temperatures above that, of up to 90° C., for 1 to 60 minutes, preferably takes place after the formation of the polymer film in stage (2a) and before implementation of stage (1b), or after the formation of the polymer film in stage (2a) and before the implementation of step (1b) there is no flashing off and no drying.

Then a commercially customary clearcoat material is applied according to stage (3) in accordance with techniques that are likewise customary, and again the coat thicknesses are in the usual ranges, as for example 5 to 100 micrometers.

Following the application of the clearcoat material, it can be flashed off and optionally dried at room temperature (20-23° C.) for 1 to 60 minutes, for example. The clearcoat material is then cured together with the applied basecoat material(s). In the course of such curing, for example, crosslinking reactions occur, and produce an effect, color and/or color and effect multicoat finish of the invention on a substrate. Curing is accomplished preferably thermally at temperatures of 60 to 200° C. The coating of plastics substrates is analogous to that of metal substrates. Here, however, curing takes place in general at much lower temperatures of 30 to 90° C. It is consequently preferable for two-component clearcoat materials to be employed.

By means of the method of the invention it is possible to coat metallic and nonmetallic substrates, especially plastics substrates, preferably automobile bodies or parts thereof. The method of the invention can additionally be used for dual coating in OEM finishing. This means that a substrate finished by means of the method of the invention is finished a second time likewise by means of the method of the invention.

The stated substrate from stage (1a) may also be a multicoat paint system possessing defects. This substrate/multicoat paint system possessing defects is therefore an original finish which is to be repaired or completely refinished. The method of the invention is suitable accordingly for repairing defects on multicoat paint systems. Defects, or film defects, generally, are faults on and in the coating, usually named according to their shape or their appearance. The skilled person knows of a great number of possible types of such film defects. They are described for example in Römpp-Lexikon Lacke and Druckfarben, Georg Thieme Verlag, Stuttgart, New York, 1998, page 235, “Film defects”.

A further subject of the present invention is a multicoat paint system obtainable in accordance with the method of the invention for producing a multicoat paint system.

All of the (preferred) observations stated above regarding the coating material composition of the invention and the method of the invention are also valid for the multicoat paint system of the invention.

### Methods of Determination

### 1. Determination of Nonvolatile Fraction

The nonvolatile fraction (the solids, i.e., the solids content) is determined according to DIN EN ISO 3251 (date: June 2008). In this case, 1 g of sample are weighed out into an aluminum dish which has been dried beforehand, and the sample is dried in a drying oven at 125° C. for 60 minutes, cooled in a desiccator, and then reweighed. The residue, relative to the total amount of sample introduced, corresponds to the nonvolatile fraction.

### 2. Determination of Average Particle Size of the Particles (B) Present in the Coating Material Composition

The average particle size of the aluminum oxide hydroxide particles present in the coating material composition and used in accordance with the invention is determined by dynamic light scattering (photon correlation spectroscopy) (PCS) according to DIN ISO 13321 (date: October 2004). Measurement takes place using a “Zetasizer Nano S-173” from Malvern Instruments at 25±1° C. The respective samples of the particles for analysis are diluted using particle-free deionized water as dispersing medium (Millipore water) to a measuring concentration in the range from 0.01% to 0.1% and are then homogenized for a duration of at least 30 minutes by means of a magnetic stirrer at 600 rpm. Aqueous NaOH solution can be added optionally, before dispersing, to increase the pH. Measurement takes place seven times. The average particle size here is understood as the arithmetic number average of the measured mean particle diameter (z-average mean).

### 3. Determination of Film Thicknesses

The film thicknesses are determined according to DIN EN ISO 2808 (date: May 2007), method 12A, using the MiniTest® 3100-4100 instrument from ElektroPhysik.

### 4. Determination of Appearance

The appearance is assessed by a corresponding assessment of the coated substrates under investigation, the assessment being carried out using a Wave scan instrument from Byk/Gardner. The substrates for investigation, coated with a multicoat paint system, are produced as follows: a perforated steel panel with dimensions of 57 cm×20 cm coated with a standard cathodic electrocoat (CathoGuard® 800 from BASF Coatings GmbH) (in accordance with DIN EN ISO 28199-1, section 8.1, version A) is prepared in analogy to DIN EN ISO 28199-1, section 8.2) (version A). This is followed by electrostatic application of the sample under investigation, such as a basecoat material of the invention, with a target film thickness (film thickness of the dried material) of 25 μm. The resulting film is dried in a forced air oven at 70° C. for 10 minutes without a flash-off time beforehand, and then recoating takes place with a commercial 2-component clearcoat material of trade brand FF99-0374 (available from BASF Coatings GmbH). The resulting clearcoat has a film thickness of 40 μm. The clearcoat was cured at 140° C. over 20 minutes. In order to assess the appearance, a laser beam is directed at an angle of 60° onto the surface under investigation, and over a measuring distance of 10 cm, the fluctuations of the reflected light in the short wave region (0.3 to 1.2 mm) and in the long wave region (1.2 to 12 mm) are recorded by means of the instrument (long wave=LW; short wave=SW; the lower the values, the better the appearance). Moreover, as a measure of the sharpness of an image reflected in the surface of the multicoat system, the instrument determines the “distinctness of image” (DOI) parameter (the higher the value, the better the appearance).

### 5. Assessment of Incidence of Pops, Runs, and Pinholes

### Assessment of Incidence of Runs—Variant a)

This assessment is made by corresponding assessment of the coated substrates under investigation. For this purpose, first of all, multicoat paint systems are produced as follows: a perforated steel panel with diagonally punched perforations and with dimensions of 57 cm×20 cm (in accordance with DIN EN ISO 28199-1 date: January 2010, section 8.1, version A), coated with a standard electrocoat (CathoGuard® 800 from BASF Coatings GmbH), is prepared in analogy to DIN EN ISO 28199-1, section 8.2 (version A). Subsequently, in a procedure based on DIN EN ISO 28199-1, section 8.3, the sample under investigation, such as a basecoat material of the invention, is applied electrostatically in a single application as a wedge with a target film thickness (film thickness of the dried material) in the range from 5 μm to 35 μm by means of electrostatically assisted bell application (1 hit ESTA). Without a flash-off time beforehand, the resulting film is dried in a forced air oven, at room temperature for 4 minutes and then at 70° C. for 10 minutes, and, after a 10-minute flash-off time at RT, is cured at 140° C. over 20 minutes. Variant a) is employed for basecoat materials comprising at least one black pigment.

### Assessment of Incidence of Runs—Variant b)

Assessment according to variant b) takes place as described for variant a), but with the difference that prior to application of the basecoat material, there is electrostatic application of a wet-on-wet primer (Color Pro 1, FA107170, available from BASF Coatings GmbH) with a target film thickness of 14 μm, and the panels thus obtained were flashed off at room temperature for 4 minutes before application of the basecoat material. Variant b) is used for basecoat materials comprising at least one red pigment.

### Assessment of Incidence of Pops and Pinholes—Variant a)

This assessment is made by corresponding assessment of the coated substrates under investigation. For this purpose, first of all, multicoat paint systems are produced as follows: a perforated steel panel with diagonally punched perforations and with dimensions of 57 cm×20 cm (in accordance with DIN EN ISO 28199-1 date: January 2010, section 8.1, version A), coated with a standard electrocoat (CathoGuard® 800 from BASF Coatings GmbH), is prepared in analogy to DIN EN ISO 28199-1, section 8.2 (version A). Subsequently, in a procedure based on DIN EN ISO 28199-1, section 8.3, the sample under investigation, such as a basecoat material of the invention, is applied electrostatically in a single application as a wedge with a target film thickness (film thickness of the dried material) in the range from 5 μm to 35 μm by means of electrostatically assisted bell application (1 hit ESTA). Without a flash-off time beforehand, the resulting film is dried in a forced air oven, at room temperature for 4 minutes and then at 70° C. for 10 minutes, and then recoated with a commercial 2-component clearcoat material of trade brand ProGloss® of type FF99-0374 (available from BASF Coatings GmbH). The resulting film thicknesses of the basecoats are between 5 μm and 35 μm; the resulting clearcoat has an average film thickness of 40 μm. The clearcoat here was cured at 140° C. over 20 minutes. Variant a) is employed for basecoat materials comprising at least one black pigment.

### Assessment of Incidence of Pops and Pinholes—Variant b)

Assessment according to variant b) takes place as described for variant a), but with the difference that prior to application of the basecoat material, there is electrostatic application of a wet-on-wet primer (Color Pro 1, FA107170, available from BASF Coatings GmbH) with a target film thickness of 14 μm, and the panels thus obtained were flashed off at room temperature for 4 minutes before application of the basecoat material. Variant b) is used for basecoat materials comprising at least one red pigment.

The popping limit, i.e., the film thickness at and above which pops occur, is determined according to DIN EN ISO 28199-3, date: January 2010, section 5. This determination is made both horizontally and vertically. The pinholing limit, i.e., the film thickness at and above which the occurrence of pinholes is observed, is determined visually. This determination may be made both horizontally and vertically. The determination of the film thickness at and above which runs occur is made according to DIN EN ISO 28199-3, date: January 2010, section 4. This determination is made vertically.

### 6. Determination of Electrical Conductivity

The electrical conductivity is determined according to DIN EN ISO 15091 (April 2013) using the “SevenCompact Mettler Toledo” instrument at 25±1° C. and a cell constant of 0.549233/cm.

### 7. Determination of Hydroxyl Number (OH Number)

The OH number is determined according to DIN 53240-2 (date: November 2007). The OH groups are reacted by acetylation with an excess of acetic anhydride. The excess acetic anhydride is subsequently split into acetic acid by addition of water, and the total acetic acid is back-titrated with ethanolic KOH. The OH number indicates the amount of KOH in mg which is equivalent to the amount of acetic acid bound in the acetylation of 1 g of sample.

### Inventive and Comparative Examples

The inventive and comparative examples below serve to illustrate the invention but should not be interpreted restrictingly.

Unless otherwise indicated, the amounts in parts are parts by weight and amounts in percent are in each case percentages by weight.

I. Determining the Average Particle Size of the Surface-Modified Boehmite Products Used within Aqueous Dispersions Prepared Therefrom

The average particle sizes were determined for various commercially available surface-modified boehmite products, namely the products “Disperal® HP 14/7”, “Disperal® HP 10/7”, and “Disperal® HP 18/7” from Sasol. All of these products are boehmite particles whose surface has been modified with citric acid. The average particle size was determined in each case by the method described above, with a set measuring concentration of 0.01%, with homogenization for a period of 30 minutes by means of a magnetic stirrer at 600 rpm, and with no use of NaOH solution. The pH of the resulting dispersions is 8.1. The average particle sizes (d₅₀, z-average mean) were obtained in the respective aqueous dispersion prepared:

Disperal® HP 10/7: 478 nm±6 nm
Disperal® HP 14/7: 357 nm±4 nm
Disperal® HP 18/7: 357 nm±4 nm.
II. Determining the Electrical Conductivity of the Surface-Modified Boehmite Products Used within Aqueous Dispersions Prepared Therefrom

Respective aqueous dispersions were prepared of the various commercially available surface-modified boehmite products “Disperal® HP 14/7”, “Disperal® HP 10/7”, and “Disperal® HP 18/7” from Sasol (in each case 20 wt % in water) and their electrical conductivity was ascertained. Determination took place in accordance with the method described above. The electrical conductivities found were as follows:

Disperal® HP 10/7 (20 wt % in water): 963 μS/cm
Disperal® HP 14/7 (20 wt % in water): 1370 μS/cm
Disperal® HP 18/7 (20 wt % in water): 1570 μS/cm
III. Investigation of Stability of the Surface-Modified Boehmite Products Used with Various Amines

Respective aqueous dispersions were prepared of the various commercially available surface-modified boehmite products “Disperal® HP 14/7”, “Disperal® HP 10/7”, and “Disperal® HP 18/7” from Sasol (in each case 15 wt % in water). Added to each of these dispersions was an aqueous solution of dimethylethanolamine (DMEA) and the stability of the dispersion with respect to amines was investigated over the course of 31 days. The measure of stability used is the change in the pH of the dispersion. A change of up to 8%, based on the original pH, is considered to be stable. Table III summarizes the results.

TABLE III

| | pH | pH | pH | pH | pH |
|---|---|---|---|---|---|
| | directly | 24 h | 14 days | 22 days | 31 days |
| | after | after | after | after | after |
| Mixture | addition | addition | addition | addition | addition |
| Mixture of | 8.68 | 8.43 | 8.13 | 8.20 | 8.15 |
| Disperal ® HP | | | | | |
| 10/7 (15 parts) | | | | | |
| and 85 parts | | | | | |
| water; addition | | | | | |
| of 6.5 parts | | | | | |
| DMEA in water | | | | | |
| (10 wt %) | | | | | |
| Mixture of | 8.76 | 8.30 | 8.05 | 8.13 | 8.11 |
| Disperal ® HP | | | | | |
| 14/7 (15 parts) | | | | | |
| and 85 parts | | | | | |
| water; addition | | | | | |
| of 9 parts DMEA | | | | | |
| in water | | | | | |
| (10 wt %) | | | | | |
| Mixture of | 8.73 | 8.28 | 8.02 | 8.09 | 8.10 |
| Disperal ® HP | | | | | |
| 18/7 (15 parts) | | | | | |
| and 85 parts | | | | | |
| water; addition | | | | | |
| of 10.5 parts | | | | | |
| DMEA in water | | | | | |
| (10 wt %) | | | | | |

The change observed in the pH was 6.1% (Disperal® HP 10/7), 7.4% (Disperal® HP 14/7) and 7.2% (Disperal® HP 18/7). All of the surface-modified boehmite products used, therefore, exhibit sufficient stability with respect to amines.

### IV. Preparation of Waterborne Basecoat Materials

### IV.1 Examples B1, B2 and B3 and Also Comparative Example C1

The components stated in Table IVa below are combined with stirring in the order stated and the resulting mixture is stirred for 30 minutes. The viscosity is adjusted in each case by addition of deionized water to a value of 107-111 mPa·s (B1: 110 mPa·s; B2: 107 mPa·s; B3: 111 mPa·s; C1: 108 mPa·s) at a shearing load of 1291 s⁻¹, measured with a rotational viscometer (Rheolab QC instrument with C-LTD80/QC heating system from Anton Paar) at 23° C. Moreover, the following pH values are ascertained: pH 8.59 (B1); pH 8.50 (B2); 8.45 (B3); pH 8.53 (C1). The solids contents (determined according to the method described above) are 28.40 wt % (B1), 28.20 wt % (B2), 28.40 wt % (B3), and 27.50 wt % (C1).

The aqueous solution used containing 3 wt % of an Na Mg phyllosilicate (Laponite® RD) is obtainable by mixing together the following constituents in this order: 3 parts by weight Laponite® RD, 0.009 part by weight 2-methylisothiazolinone, 0.005 part by weight 1,2-benz-isothiazol-3(2H)-one, 3 parts by weight propylene glycol, and 93.986 parts by weight deionized water.

Employed as “pigment paste P1” was a pigment paste obtainable by mixing together the following constituents in this order: 9 parts by weight carbon black (“Emperor 200” from Cabot), 2.5 parts by weight polypropylene glycol, 7 parts by weight butyl diglycol, 21.5 parts by weight deionized water, 4.5 parts by weight a polyester prepared as per Example D, column 16, lines 37-59 of DE A 4009858, 53 parts by weight a polyurethane, and 2 parts by weight an aqueous dimethylethanolamine solution (10 wt % in water).

The “AMP-PTSA solution” used is a solution obtainable by mixing together the following constituents in this order: 30.3 parts by weight isopropanol, 13.6 parts by weight 1-propanol, 10 parts by weight deionized water, 30.3 parts by weight 4-methylbenzenesulfonic acid, and 15.8 parts by weight 2-amino-2-methyl-1-propanol.

TABLE IVa
Examples B1 to B3 and Comparative Example C1

| | | | | Comparative |
|---|---|---|---|---|
| | Example B1 | Example B2 | Example B3 | Example C1 |
| Aqueous solution containing 3 wt % of | — | — | — | 15.65 |
| an Na Mg phyllosilicate (Laponite ® RD) | | | | |
| Deionized water | — | — | — | 1.00 |
| 2,4,7,9-Tetramethyl-5-decynediol in | — | — | — | 0.75 |
| butyl glycol (50 wt %) | | | | |
| Acrylated polyurethane; prepared as per | 36.00 | 36.00 | 36.00 | 36.00 |
| Example D-C1 of WO 2015/007427 A1 | | | | |
| Deionized water | 1.00 | 1.00 | 1.00 | 1.00 |
| Polyurethane-modified polyacrylate; | 3.00 | 3.00 | 3.00 | 3.00 |
| prepared as per page 7, line 55 to | | | | |
| page 8, line 23 of DE 4437535 A1 | | | | |
| 2,4,7,9-Tetramethyl-5-decynediol in | 1.50 | 1.50 | 1.50 | 0.92 |
| butyl glycol (50 wt %) | | | | |
| Dimethylethanolamine (10 wt % in water) | 0.50 | 0.50 | 0.50 | 0.50 |
| Disperal ® HP 10/7 | 2.48 | — | — | — |
| Disperal ® HP 14/7 | — | 2.48 | — | — |
| Disperal ® HP 18/7 | — | — | 2.48 | — |
| Deionized water | 14.03 | 14.03 | 14.03 | — |
| Dimethylethanolamine (10 wt % in water) | 1.07 | 1.49 | 1.74 | — |
| 2,4,7,9-Tetramethyl-5-decynediol in | 0.17 | 0.17 | 0.17 | — |
| butyl glycol (50 wt %) | | | | |
| Isopropanol | 1.50 | 1.50 | 1.50 | 1.50 |
| Butyl glycol | 1.50 | 1.50 | 1.50 | 1.50 |
| Propylene glycol monobutyl ether | 1.50 | 1.50 | 1.50 | 1.50 |
| Butyl diglycol | 1.80 | 1.80 | 1.80 | 1.80 |
| Polyester; prepared as perpage 28, | 4.00 | 4.00 | 4.00 | 4.00 |
| lines 13 to 33 (Example BE1) of WO | | | | |
| 2014/033135 A2 | | | | |
| Melamine formaldehyde resin | 1.00 | 1.00 | 1.00 | 1.00 |
| (Cymel ® 1133 from Allnex) | | | | |
| Melamine formaldehyde resin | 4.00 | 4.00 | 4.00 | 4.00 |
| (Maprenal ® MF 909/93IB from Ineos) | | | | |
| Dimethylethanolamine (10 wt % in water) | 0.50 | 0.50 | 0.50 | 0.50 |
| Deionized water | 1.00 | 1.00 | 1.00 | — |
| 2-Ethylhexanol | 3.00 | 3.00 | 3.00 | 3.00 |
| n-Propanol | 0.70 | 0.70 | 0.70 | 0.70 |
| Isopar ® L (mixture of C₁₁-C₁₃ paraffins) | 0.70 | 0.70 | 0.70 | 0.70 |
| Pluriol ® P900, available from BASF SE | 1.20 | 1.20 | 1.20 | 1.20 |
| AMP-PTSA solution | 0.50 | 0.50 | 0.50 | 0.50 |
| Deionized water | 1.00 | 1.00 | — | — |
| Pigment paste P1 | 15.00 | 15.00 | 15.00 | 15.00 |
| | Σ 98.65 | Σ 99.07 | Σ 98.32 | Σ 95.72 |

The numerical figures correspond in each case to parts by weight.

### IV.2 Example B4 and Comparative Examples C2 and C3

The components listed in Table IVb are stirred together in the order stated and the resulting mixture is stirred for 30 minutes. The viscosity is adjusted in each case by addition of deionized water to a level of 100-110 mPa·s under a shearing load of 1291 s⁻¹, measured using a rotational viscometer (Rheolab QC instrument with C-LTD80/QC heating system from Anton Paar) at 23° C. The pH values of the waterborne basecoat materials thus obtained are pH 8.48 (B4) and 8.70 (C2). The solids contents (determined according to the method described above) are 30.0 wt % (B4) and 29.3 wt % (C2).

Employed as filler paste F1 was a barium sulfate-containing paste obtainable by competent grinding and subsequent homogenizing of the following constituents in this order: 54.00 parts by weight of barium sulfate, Blanc Fixe Micro, available from Sachtleben Chemie, 0.3 part by weight of Agitan 282 defoamer, available from Munzing Chemie, 4.6 parts by weight of 2-butoxyethanol, 5.7 parts by weight of deionized water, parts by weight of a polyester prepared as per Example D, column 16, lines 37-59 of DE A 4009858, and 32.4 parts by weight of a polyurethane.

Employed as filler paste F2 was a talc-containing paste obtainable by competent grinding and subsequent homogenizing of the following constituents in this order: 28 parts by weight of talc of brand Micro Talc IT Extra, available from Mondo Minerals, 0.4 part by weight of Agitan 282 defoamer, available from Munzing Chemie, 1.4 parts by weight of Disperbyk® 184, available from BYK Chemie, Wesel, 0.6 part by weight of Rheovis AS 130 acrylate thickener, available from BASF SE, 1 part by weight of 2-butoxyethanol, 3 parts by weight of Pluriol P 900, available from BASF SE, 18.4 parts by weight of deionized water, 47 parts by weight of an acrylate polymer (binder dispersion A from patent application WO 91/15528 A1), and 0.2 part by weight of an aqueous dimethylethanolamine solution (10 wt % in water).

TABLE IVb
Example B4 and Comparative Examples C2 and C3

| | | Comparative | Comparative |
|---|---|---|---|
| | Example B4 | Example C2 | Exampl C3 |
| Aqueous solution containing 3 wt % of | — | 11.70 | — |
| an Na Mg phyllosilicate (Laponite ® RD) | | | |
| Deionized water | — | 1.90 | — |
| 2,4,7,9-Tetramethyl-5-decynediol in | — | 0.60 | — |
| butyl glycol (50 wt %) | | | |
| Acrylated polyurethane; prepared as per | 28.70 | 28.70 | 28.70 |
| Example D-C1 of WO 2015/007427 A1 | | | |
| 2,4,7,9-Tetramethyl-5-decynediol in | 0.65 | — | 0.65 |
| butyl glycol (50 wt %) | | | |
| Deionized water | 1.40 | 1.40 | 1.40 |
| Polyurethane-modifiedpolyacrylate; | 2.40 | 2.40 | 2.40 |
| prepared as per page 7, line 55 to | | | |
| page 8, line 23 of DE 4437535 A1 | | | |
| 2,4,7,9-Tetramethyl-5-decynediol in | 0.60 | 0.60 | 0.60 |
| butyl glycol (50 wt %) | | | |
| Dimethylethanolamine (10 wt % in water) | 0.40 | 0.40 | 0.40 |
| Disperal ® HP 14/7 | 2.00 | — | — |
| Deionized water | 11.40 | — | 11.40 |
| Dimethylethanolamine (10 wt % in water) | 1.14 | — | 1.14 |
| 2,4,7,9-Tetramethyl-5-decynediol in | 0.13 | — | 0.13 |
| butyl glycol (50 wt %) | | | |
| Isopropanol | 1.40 | 1.40 | 1.40 |
| Butyl glycol | 1.00 | 1.00 | 1.00 |
| Propylene glycol monobutyl ether | 1.20 | 1.20 | 1.20 |
| Butyl diglycol | 1.40 | 1.40 | 1.40 |
| Polyester; prepared as per page 28, | 3.00 | 3.00 | 3.00 |
| lines 13 to 33 (Example BE1) of WO | | | |
| 2014/033135 A2 | | | |
| Melamine-formaldehyde resin | 4.00 | 4.00 | 4.00 |
| (Maprenal ® MF 909/93IB from Ineos) | | | |
| Dimethylethanolamine (10 wt % in water) | 0.40 | 0.40 | 0.40 |
| 2-Ethylhexanol | 2.40 | 2.40 | 2.40 |
| n-Propanol | 0.50 | 0.50 | 0.50 |
| Isopar ® L (mixture of C₁₁-C₁₃ paraffins) | 0.50 | 0.50 | 0.50 |
| AMP-PTSA solution | 0.40 | 0.40 | 0.40 |
| Deionized water | 2.00 | 2.00 | 2.00 |
| Pigment paste P1 | 11.70 | 11.70 | 11.70 |
| Filler paste F1 | 3.30 | 3.30 | 3.30 |
| Filler paste F2 | 3.30 | 3.30 | 3.30 |
| Pluriol ® P900 | 1.00 | 1.00 | 1.00 |
| | Σ 86.32 | Σ 85.20 | Σ 84.32 |

The numerical figures correspond in each case to parts by weight.

### IV.3 Example B5 and Comparative Examples C4 and C5

The components listed in Table IVc are stirred together in the order stated and the resulting mixture is stirred for 30 minutes. The viscosity is adjusted in each case by addition of deionized water to a level of 110-120 mPa·s under a shearing load of 1291 s⁻¹, measured using a rotational viscometer (Rheolab QC instrument with C-LTD80/QC heating system from Anton Paar) at 23° C. The pH values of the waterborne basecoat materials thus obtained are pH 8.17 (B5) and 8.80 (C4). The solids contents (determined according to the method described above) are 30.4 wt % (B5) and 29.0 wt % (C4).

TABLE IVc
Example B5 and Comparative Examples C4 and C5

| | | Comparative | Comparative |
|---|---|---|---|
| | Example B5 | Example C4 | Example C5 |
| Aqueous solution containing 3 wt % of | — | 11.70 | — |
| an Na Mg phyllosilicate (Laponite ® RD) | | | |
| Deionized water | — | 2.10 | — |
| 2,4,7,9-Tetramethyl-5-decynediol in | — | 0.70 | — |
| butyl glycol (50 wt %) | | | |
| Formula H as per DE 19914055 A1 | 28.20 | 28.20 | 28.20 |
| Disperal ® HP 14/7 | 1.50 | — | — |
| Deionized water | 8.50 | — | 8.50 |
| Dimethylethanolamine (10 wt % in water) | 0.85 | — | 0.85 |
| 2,4,7,9-Tetramethyl-5-decynediol in | 0.10 | — | 0.10 |
| butyl glycol (50 wt %) | | | |
| Crosslinker | 4.90 | 4.90 | 4.90 |
| Isopropanol | 1.90 | 1.90 | 1.90 |
| Butyl glycol | 2.80 | 2.80 | 2.80 |
| Polyester; prepared as per page 28, | 3.50 | 3.50 | 3.50 |
| lines 13 to 33 (Example BE1) of WO | | | |
| 2014/033135 A2 | | | |
| Dimethylethanolamine (10 wt % in water) | 2.20 | 2.20 | 2.20 |
| Deionized water | 1.00 | 1.00 | 1.00 |
| Polyurethane-modified polyacrylate; | 2.80 | 2.80 | 2.80 |
| prepared as per page 7, line 55 to | | | |
| page 8, line 23 of DE 4437535 A1 | | | |
| 2,4,7,9-Tetramethyl-5-decynediol in | 1.50 | 1.50 | 1.50 |
| butyl glycol (50 wt %) | | | |
| Deionized water | 0.80 | 0.80 | 0.80 |
| Rheovis ® AS 1130 | 2.50 | 2.50 | 2.50 |
| Deionized water | 0.80 | 0.80 | 0.80 |
| Texanol ® | 2.20 | 2.20 | 2.20 |
| Pluriol ® P900 | 1.00 | 1.00 | 1.00 |
| Hydroxyphenylalkylbenzotriazole | 0.70 | 0.70 | 0.70 |
| bis(Octyltetramethylpiperidyl) sebacate | 0.40 | 0.40 | 0.40 |
| Deionized water | 0.50 | 0.50 | 0.50 |
| Daotan ® TW 6464/36 WA | 1.90 | 1.90 | 1.90 |
| Deionized water | 0.60 | 0.60 | 0.60 |
| WBM Paste 4 | 15.80 | 15.80 | 15.80 |
| WBM Paste 5 | 1.40 | 1.40 | 1.40 |
| WBM Paste 6 | 1.20 | 1.20 | 1.20 |
| Deionized water | 1.10 | 1.10 | 1.10 |
| | Σ 90.65 | Σ 94.20 | Σ 89.15 |

The numerical figures correspond in each case to parts by weight.

Employed as WBM paste 4 was a DPP red paste obtainable by competent grinding and subsequent homogenization of the following constituents in this order: 34.50 parts by weight of Irgazine Red L 3663 HD, available from BASF SE Ludwigshafen, 8.5 parts by weight of Disperbyk 184, available from BYK-Chemie, Wesel, 2 parts by weight of 1-propoxy-2-propanol, 2 parts by weight of Pluriol P 900, available from BASF SE, 18 parts by weight of deionized water, and 35 parts by weight of an acrylate polymer (binder dispersion A from patent application WO 91/15528 A1).

Employed as WBM paste 5 was a red paste obtainable by competent grinding and subsequent homogenization of the following constituents in this order: 30 parts by weight of Cinilex Red SR3C, available from Cinic, China, 6.0 parts by weight of Disperbyk 184, available from BYK-Chemie, Wesel, 25.5 parts by weight of deionized water, and 38.5 parts by weight of an acrylate polymer (binder dispersion A from patent application WO 91/15528 A1).

Employed as WBM paste 6 was a titanium dioxide-based white paste obtainable by competent grinding and subsequent homogenization of the following constituents in this order: 50 parts by weight of Titan Rutile R 960, available from Chemours, 3 parts by weight of butyl glycol, 1.5 parts by weight of Pluriol P 900, available from BASF SE, 11 parts by weight of a polyester, 16 parts by weight of a polyurethane dispersion prepared as per WO 92/15405, page 15, lines 23-28, and 1.5 parts by weight of an aqueous dimethylethanolamine solution (10 wt % in water).

The crosslinker employed was a blocked isocyanate which was prepared as follows: 230 parts by weight of the hydrophilic isocyanate Bayhydur 304, available from Covestro, and 40.76 parts by weight of butyl glycol were charged to a stainless steel reactor which was blanketed with nitrogen. The reactor was subsequently closed and 96.13 parts by weight of 3,5-dimethylpyrazole (DMP) were added in portions at a rate such that the temperature did not exceed 60° C. Following addition of the complete amount of DMP together with a further 40.76 parts by weight of butyl glycol, the batch was heated to 80° C. and the temperature was held at 80° C. for 2 hours, during which stirring and further nitrogen blanketing took place. When determination of the percent NCO content yielded 0%, the reaction mixture was discharged. The resulting crosslinker had a solids content of 79.8% (125° C., 1 h).

### V. Investigations and Comparison of the Properties of the Aqueous Basecoat Materials and of the Coatings Obtained Therefrom

### V.1 Comparison Between B1, B2 and B3 (all Inventive) and Also C1 in Respect of Appearance and of Incidence of Pinholes, Pops and Runs

The investigations each took place according to the methods of determination described above. Table Va summarizes the results.

TABLE Va
Vertical flow (18-23 μm)

| | | | | | | Pin- |
|---|---|---|---|---|---|---|
| | | | | | Popping | holing |
| | | | | | limit | limit |
| | SW | LW | DU | DOI | [μm] | [μm] |
| Example B1 | 14.3 | 5.7 | 1 | 96 | >30 | 29 |
| Example B2 | 14.5 | 5.3 | 1 | 95.5 | >30 | 31 |
| Example B3 | 13.6 | 5.1 | 1 | 95.7 | >30 | 30 |
| Comparative | 8.4 | 7.3 | 1 | 97.5 | >30 | >30 |
| Example C1 | | | | | | |

These investigations show that much better LW values were obtained for B1 to B3 than for C1.

### V.2 Comparison Between B4 (Inventive) and C2 in Respect of Appearance

An attempt was made to investigate C3 as well for comparison with B4, but C3 could not be applied in accordance with the method of determination described above, because the formulation was unstable to running and consequently the panels obtained could not be evaluated.

The investigations each took place according to the methods of determination described above. Tables Vb and Vc summarize the results.

TABLE Vb
Vertical flow (18-23 μm)

| | SW | LW | DU | DOI |
|---|---|---|---|---|
| Example B4 | 12.1 | 5.6 | 1 | 95.5 |
| Comparative | 12.7 | 8.0 | 1 | 94.8 |
| Example C2 | | | | |

TABLE Vc
Horizontal flow (18-23 μm)

| | SW | LW | DU | DOI |
|---|---|---|---|---|
| Example B4 | 11.0 | 2.8 | 1 | 95.9 |
| Comparative | 12.5 | 4.4 | 1 | 94.9 |
| Example C2 | | | | |

These investigations show in particular that much better LW values were obtained for B4 than for C2.

### V.3 Comparison Between B5 (Inventive) and C4 in Respect of Pinholing and Running Limits

An attempt was made to investigate C5 as well for comparison with B5, but C5 could not be applied in accordance with the method of determination described above, because the formulation was unstable to running and consequently the panels obtained could not be evaluated. The investigations each took place according to the methods of determination described above. Table Vd summarizes the results.

TABLE Vd

| | | | Start of |
|---|---|---|---|
| | Pinholing | Pinholing | appearance |
| | limit | limit | of runs |
| | (horizontal) | (vertical) | (vertical) |
| | [μm] | [μm] | [μm] |
| Example B5 | 22 | 25 | 27 |
| Comparative | 12 | 18 | 17 |
| Example C4 | | | |

These investigations show in particular that a much better pinhole robustness was observed for B5 in comparison to C4.

### VI. Compatibility Experiments (Stability Experiments)

Mixtures are prepared from the following constituents: 15 parts by weight of Disperal® HP 14/7, 85 parts by weight of deionized water and 2.5 parts by weight of an alcoholic solution containing 30 wt % diazabicyclononene and 70 wt % n-butanol. The mixture was stirred for a time of 30 minutes to give a mixture M1.

The mixture M1 was then combined respectively with materials P1 to P6 below, in a weight ratio of 1:1, and the resulting mixtures were homogenized and their stability investigated visually after 3 days of storage at 23° C. (rating 1: stable, no bits; rating 2: a few bits formed; rating 3: bits formed):

P1: Formula H as per DE 19914055 A1 (solids content: 27 wt %)
P2: Dispersion PD 1 as per WO 2018/011311 A1 (solids content: 40.2 wt %)
P3: Daotan® TW 6464/36 WA (commercially available acrylated polyurethane from Allnex; solids content: 36 wt %)
P4: Example D-C1 of WO 2015/007427 A1 (solids content: 32.8 wt %)
P5: Dispersion of a polyurethane-modified polyacrylate as per DE 4437535 A1, page 7, line 55 to page 8, line 23 (solids content: 36 wt %)
P6: Polyester, prepared as per Example D, column 16, lines 37-59 of DE 40 09 858 A1 (solids content: 60 wt %)

In all cases it was possible to award “rating 1”; in other words, no stability problems and/or compatibility problems were observable.

### VII. Investigations of the Thixotroping Behavior

Mixtures are prepared from the following constituents: 15 parts by weight of Disperal® HP 10/7 or Disperal® HP 14/7 or Disperal® HP 18/7 and 85 parts by weight of deionized water. Dimethylethanolamine (10 wt % in water) is used to set a pH of 8.0 to 8.3. The mixtures were stirred for a time of 30 minutes to give a mixture M2 (with Disperal® HP 10/7), M3 (with Disperal® HP 14/7) and M4 (with Disperal® HP 18/7).

These mixtures were then admixed with different materials K1 to K5 in different weight ratios to one another, and homogenized. The materials in question are:

K1: Daotan® TW 6464/36 WA (commercially available acrylated polyurethane from Allnex; solids content: 36 wt %)
K2: Formula H as per DE 19914055 A1 (solids content: 27 wt %)
K3: Example D-C1 of WO 2015/007427 A1 (solids content: 32.8 wt %)
K4: Dispersion PD 1 as per WO 2018/011311 A1 (solids content: 40.2 wt %)
K5: Example wD BM2 as per Table A of WO 2018/011311 A1 (solids content: 25.5 wt %)

Table VIIa summarizes the results.

TABLE VIIa

| Material | M2 | M3 | M4 |
|---|---|---|---|
| [wt %] | [wt %] | [wt %] | [wt %] |
| K1, 80% | 20% | | |
| K1, 60% | 40% | | |
| K2, 60% | 40% | | |
| K3, 80% | 20% | | |
| K3, 60% | 40% | | |
| K4, 80% | 20% | | |
| K4, 60% | 40% | | |
| K5, 80% | 20% | | |
| K5, 60% | 40% | | |
| K1, 80% | | 20% | |
| K1, 60% | | 40% | |
| K2, 60% | | 40% | |
| K3, 80% | | 20% | |
| K3, 60% | | 40% | |
| K4, 80% | | 20% | |
| K4, 60% | | 40% | |
| K5, 80% | | 20% | |
| K5, 60% | | 40% | |
| K1, 80% | | | 20% |
| K1, 60% | | | 40% |
| K2, 60% | | | 40% |
| K3, 80% | | | 20% |
| K3, 60% | | | 40% |
| K4, 80% | | | 20% |
| K4, 60% | | | 40% |
| K5, 80% | | | 20% |
| K5, 60% | | | 40% |

In all cases where one of the mixtures M2 to M4 was mixed with one of the materials K1 to K5 in the specified weight ratios, no instances of incompatibility at all were observable and the mixtures all exhibited structurally viscous behavior.

1. An aqueous coating material composition, the composition comprising:
(A) at least one polymer employable as binder, as component (A), and
(B) aluminum oxide hydroxide particles, as component (B),
where the aqueous coating material composition has a pH≥7.5,
wherein the aqueous coating material composition comprises component (B) in an amount of at least 0.1 wt %, based on a solids content of the aqueous coating material composition, and a surface of the aluminum oxide hydroxide particles employed as component (B) is at least partly modified with at least one organic acid.

2. The aqueous coating material composition as claimed in claim 1, wherein a relative weight ratio of component (B) to component (A) in the aqueous coating material composition is in a range from 1:1.1 to 1:20.

3. The aqueous coating material composition as claimed in claim 1, wherein at least partial modification is accomplished by treating the aluminum oxide hydroxide particles with at least one organic carboxylic acid.

4. The aqueous coating material composition as claimed in claim 1, wherein the at least one organic acid used for modifying the aluminum oxide hydroxide particles has at least two carboxylic acid groups.

5. The aqueous coating material composition as claimed in claim 1, wherein the surface of the aluminum oxide hydroxide particles employed as component (B) is modified at least partly with citric acid as the at least one organic acid.

6. The aqueous coating material composition as claimed in claim 1, wherein the aluminum oxide hydroxide particles employed as component (B) are present in the aqueous coating material composition in a form of particles which have an average particle size (d₅₀) of ≤750 nm, the average particle size referring to an arithmetic number average of an average particle diameter, and the average particle size being determined by means of photon correlation spectroscopy (PCS).

7. The aqueous coating material composition as claimed in claim 6, wherein the aluminum oxide hydroxide particles employed as component (B) are present in the aqueous coating material composition in the form of particles which have an average particle size in a range from ≥75 nm to ≤750 nm.

8. The aqueous coating material composition as claimed in claim 1, which comprises component (B) in an amount of at least 0.5 wt %, based on the solids content of the coating material composition.

9. The aqueous coating material composition as claimed in claim 1, which has a solids content of >25 wt %, based on a total weight of the aqueous coating material composition.

10. The aqueous coating material composition as claimed in claim 1, which is an aqueous basecoat material.

11. The aqueous coating material composition as claimed claim 1, which further comprises at least one pigment and/or at least one filler.

12. The aqueous coating material composition as claimed in claim 1, wherein the at least one polymer employed as component (A) is selected from the group consisting of polyurethanes, polyesters, poly(meth)acrylates, and copolymers thereof.

13. A method for producing a multicoat paint system, the method comprising:
(1a) applying an aqueous basecoat material to an optionally coated substrate,
(2a) forming a polymer film from the aqueous basecoat material applied in stage (1a),
(1b) optionally applying a further aqueous basecoat material to the polymer film thus formed,
(2b) optionally forming a polymer film from the aqueous basecoat material applied in stage (1b),
(3) applying a clearcoat material to resulting basecoat film or films, and subsequently
(4) jointly curing together the aqueous basecoat film or films with the clearcoat material,
wherein the aqueous coating material composition as claimed in claim 1 is used as the aqueous basecoat material in stage (1a) or—where the method further comprises stages (1b) and (2b)—as the aqueous basecoat material in stage (1a) and/or (1b).

14. The method as claimed in claim 13, wherein the method further comprises stages (1b) and (2b) and the coated substrate used in stage (1a) is a metallic substrate whose surface for coating in stage (1a) has been provided at least with an electrocoat film.

15. A multicoat paint system obtainable by the method as claimed in claim 13.
